(19) United States
(12) Patent Application Publication
(10) Pub. No.: US 2022/0106936 A1
(43) Pub. Date: Apr. 7, 2022

(54) WIND POWER GENERATION DEVICE

(71) Applicant: Laihuan LUO, Ji'an (CN)

(72) Inventor: Laihuan LUO, Ji'an (CN)

(21) Appl. No.: 17/644,342

(22) Filed: Dec. 15, 2021

Related U.S. Application Data
(63) Continuation of application No. PCT/CN2021/109997, filed on Aug. 2, 2021.

(30) Foreign Application Priority Data
Aug. 26, 2020 (CN) 202010867953.3

(51) Int. Cl. F03D 3/02; F03D 9/25; F03D 15/10

(52) U.S. Cl. CPC F03D 3/02; F03D 15/10; F03D 9/25

(57) ABSTRACT

A wind power generation device includes an upper plate, a lower plate, and impellers located between the upper plate and the lower plate, wherein the upper plate and the lower plate are arranged oppositely and parallelly with respect to each other; a plurality of impellers are arranged between the upper plate and the lower plate; the impellers are arranged in two rows; each row of the two rows of the impellers are connected through a transmission mechanism; a plane where the two rows of the impellers are located form an included angle; a wind deflector is arranged at the included angle; the two rows of the impellers include a first power impeller and a second power impeller which are closest to the wind deflector; a linkage structure is arranged between the first power impeller and the second power impeller; and the first power impeller is connected to an electric generator.

### CROSS REFERENCE TO THE RELATED APPLICATIONS

This application is the Continuation application of International Application No. PCT/CN2021/109997, filed on Aug. 2, 2021, which is based upon and claims priority to Chinese Patent Application No. 202010867953.3, filed on Aug. 26, 2020, the entire contents of which are incorporated herein by reference.

### TECHNICAL FIELD

The present invention belongs to the technical field of wind power generation, and in particular, to a wind power generation device.

### BACKGROUND

Wind energy, as a clean and pollution-free renewable energy source, has attracted more and more attention. Wind power generation will become one of the largest new energy sources in the 21st century. The wind power generator is an electric device that converts wind energy into mechanical energy and converts the mechanical energy into electric energy. Broadly speaking, the wind power generator is a heat energy utilization engine taking the sun as a heat source and the atmosphere as a working medium. At present, the biggest disadvantages of the wind power generator are large occupied area, single orientation and low wind power collecting efficiency for the ever-changing wind direction in one day. Moreover, the existing wind power generation device has single application environment, and cannot be applied to the sea surface or land synchronously, thereby reducing the use range.

### SUMMARY

An objective of the present invention is to provide a wind power generation device. The wind power generation deice has a simple structure, can change the size according to the requirement, can be applied to the sea surface or land, and achieves the aim of generating electricity under different environments by cooperating with different fixed structures.

To achieve the above objective, the present invention adopts the following technical solution: a wind power generation device includes an upper plate, a lower plate, and impellers located between the upper plate and the lower plate, wherein the upper plate and the lower plate are arranged oppositely and parallelly with respect to each other; a plurality of impellers are arranged between the upper plate and the lower plate; the impellers are arranged in two rows; each row of the two rows of the impellers are connected through a transmission mechanism to realize synchronous rotation; a plane where the two rows of the impellers are located form an included angle; a wind deflector is arranged at the included angle; the two rows of the impellers include a first power impeller and a second power impeller respectively, wherein the first power impeller and a second power impeller are closest to the wind deflector; a linkage structure is arranged between the first power impeller and the second power impeller; and the linkage structure is connected to an electric generator.

The further improved technical solution in the above technical solutions is as follows:

in the above solution, the impeller includes a center shaft, a sleeve and a plurality of blades; two ends of the center shaft are connected to the upper plate and the lower plate respectively; the sleeve is fixed outside the center shaft; and the plurality of blades are arranged outside the sleeve.

In the above solution, the transmission mechanism of each row of the two rows of the impellers is a plurality of gears which are engaged together and divided into upper gears and lower gears, each of the upper gears is mounted outside an upper end of the center shaft, a first side of each of the upper gears abuts against the upper plate, an upper partition plate is arranged on a second side of each of the upper gears opposite to the upper plate, and the upper gears are located between the upper plate and the upper partition plate; each of the lower gears is mounted outside a lower end of the center shaft, a first side of each of the lower gears abuts against the lower plate, a lower partition plate is arranged on a second side of each of the lower gears opposite to the lower plate, and the lower gears are located between the lower plate and the lower partition plate.

In the above solution, an upper transition gear and a lower transition gear are arranged between two adjacent center shafts, the upper transition gear is located between two adjacent upper gears, and the upper transition gear is fixed between the upper plate and the upper partition plate through a short shaft; and the lower transition gear is located between two adjacent lower gears, and the lower transition gear is fixed between the lower plate and the lower partition plate through the short shaft.

In the above solution, the linkage structure between the first power impeller and the second power impeller is a first power gear and a second power gear, the first power gear and the second power gear are engaged with each other, the first power gear is arranged on the center shaft of the first power impeller, the second power gear is arranged on the center shaft of the second power impeller, and the first power gear and the second power gear are arranged close to the lower gears and are located on one side of the lower partition plate opposite to the lower gears.

In the above solution, the first power impeller transmits power to the electric generator through a first bevel gear and a second bevel gear which are matched with each other, the first bevel gear is mounted on the center shaft of the first power impeller, the first bevel gear is in engaged connection with the second bevel gear, and the electric generator is connected to the second bevel gear through a transmission shaft.

In the above solution, the transmission mechanism of each row of the two rows of the impellers includes a plurality of steering gears, the steering gear includes a gear box, and a first steering bevel gear and a second steering bevel gear which are located in the gear box, and the first steering bevel gear and the second steering bevel gear are in engaged connection with each other; upper surfaces of the upper plate and the lower plate are respectively provided with two rows of the steering gears arranged in a distribution direction of the two rows of the impellers, each row of steering gears are connected together through a steering shaft, the first steering bevel gear in each steering gear is fixedly connected to an end part of the center shaft of the corresponding impeller, the second steering bevel gear is connected to the steering shaft, and when the impeller rotates, the center shaft and the first steering bevel gear rotate synchronously and simultaneously drive the second steering bevel gear to rotate; and

the upper surfaces of the upper plate and the lower plate are fixedly connected to an upper partition plate and a lower partition plate respectively, the upper partition plate and the lower partition plate are mounted on the upper plate and the lower plate through a bracket, the steering gear mounted on the upper surface of the upper plate and the steering shaft are located between the upper plate and the upper partition plate, and the steering gear mounted on the upper surface of the lower plate and the steering shaft are located between the lower plate and the lower partition plate.

In the above solution, the linkage structure between the first power impeller and the second power impeller includes a transmission shaft and a third steering bevel gear, one third steering bevel gear is arranged in each of the steering gears connected below the first power impeller and the second power impeller, two third steering bevel gears are respectively engaged with the first steering bevel gears in the two steering gears, one transmission shaft is arranged between the two third steering bevel gears, and when the third steering bevel rotates, the transmission shaft rotates synchronously, one steering gear is arranged in the middle of the transmission shaft, and the electric generator is connected to the steering gear; and the first steering bevel gear of the steering gear is mounted on the transmission shaft, and the second steering bevel gear is connected to the electric generator.

In the above solution, bearings are arranged at the connections between the center shaft, and the upper plate, the lower plate, the upper partition plate and the lower partition plate, and the short shaft is connected to the upper plate, the lower plate, the upper partition plate and the lower partition plate through the bearings; and

the center shaft, the transmission shaft, the steering shaft and the gear box are connected through the bearings.

In the above solution, the upper plate and the lower plate are two triangular plates with a consistent direction, the two rows of the impellers are distributed along two hypotenuses of the triangular plates, the wind deflector is arranged at the included angle of the two rows of the impellers, the included angle of the two rows of the impellers is 50°-60°, two sides of the wind deflector are respectively parallel with the two planes where the two rows of the impellers are located, and an upper end and a lower end of the wind deflector are fixed on the upper plate and the lower plate respectively.

In the above solution, when being used on the land, the wind power generation device further includes a fixing device, wherein the fixing device includes an empennage, a pedestal, a supporting shaft, a first supporting base and a second supporting base, the first supporting base is mounted on a lower surface of the upper plate, the second supporting base is mounted on a lower surface of the lower plate, the positions of the first supporting base and the second supporting base correspond to each other up and down, the first supporting base and the second supporting base are connected through the supporting shaft penetrating through the lower plate, a lower end of the supporting shaft is fixed on the pedestal, the supporting shaft is arranged on a connecting line of the gravity center of the wind power generation device and the end part of the wind deflector, and bearings are arranged at the connections between the supporting shaft, and the first supporting base and the second supporting base; and the empennage is mounted on an upper surface of the upper plate, arranged between the two rows of the impellers and distributed along a symmetry axis of the two rows of the impellers, and the tail end of the empennage extends outside the upper plate.

In the above solution, when being used at the sea surface, the wind power generation device further includes a floating device, a fixing pile and a rope; the lower plate is fixed on the floating device; the floating device floats on the water surface, one end of the floating device is connected to the fixing pile through the rope, the fixing pile is fixed under water, and the connecting ends of the rope and the floating device are positioned directly opposite to a tip of the wind deflector.

In the above solution, the wind power generation device may be provided with a multi-layer structure, and each layer of structure is provided with an electric generator, so that wind energy can be collected better, and the power generation efficiency can be improved.

In the above solution, the floating device is a ship.

In the above solution, the blade may be a flat blade, or may also an arc-shaped blade.

Due to the application of the above technical solutions, compared with the prior art, the present invention has the following advantages:

1. According to the wind power generation device provided by the present invention, the impellers are used to convert wind power into kinetic energy; through the design of a plurality of gears, the kinetic energy is transmitted to the electric generator to realize wind power generation; and the wind power generation device has a simple structure, can change the size according to the requirement, may be applied to a sea surface or land and cooperates with different fixed structures to fulfill the aims of generating electricity under different environments.

2. According to the wind power generation device provided by the present invention, the wind deflector is provided and may guide wind, so that the wind moves in a V shape; then the impellers are arranged into two rows in a V shape to just correspond to the wind passing through the wind deflector, and wind drives the impellers to rotate and converts wind energy into kinetic energy; and the impellers are connected through gears or steering gears in a transmission manner to realize transmission of the kinetic energy, and when the steering gear is used, the overall structure can be lighter.

3. The wind power generation device provided by the present invention is provided with the wind deflector and the two rows of the impellers to divide wind energy into two parts, so that the utilization rate of the wind energy and the power generation efficiency can be improved.

4. When the wind power generation device provided by the present invention generates electricity on the land and is used in cooperation with the fixing device the direction can be changed at any time to be consistent with the wind direction from beginning to end, so that the power generation efficiency is improved; meanwhile, when the wind power generation device generates electricity on the sea surface and is used in cooperation with the floating device, the direction of the device may be changed with the wind direction so as to meet the use of the wind power generation device in different wind directions.

### BRIEF DESCRIPTION OF THE DRAWINGS

FIG. 1 is a structural schematic diagram of an embodiment 1 of the present invention.

FIG. 2 is a section view of an embodiment 1 of the present invention.

FIG. 3 is a mounting schematic diagram of an electric energy of an embodiment 1 of the present invention.

FIG. 4 is a schematic diagram of a mounting structure of a first bevel gear and a second bevel gear according to an embodiment 1 of the present invention.

FIG. 5 is a structural schematic diagram of single impeller according to an embodiment 1 of the present invention.

FIG. 6 is a schematic diagram of connection of a short shaft and a transition gear according to an embodiment 1 of the present invention.

FIG. 7 is a structural schematic diagram of an embodiment 1 of the present invention.

FIG. 8 is a schematic diagram of a fixing device according to an embodiment 1 of the present invention.

FIG. 9 is a structural schematic diagram of an embodiment 2 of the present invention.

FIG. 10 is a schematic diagram of an included angle of two rows of impellers according to the present invention.

FIG. 11 is a schematic diagram of a use structure according to an embodiment 3 of the present invention.

FIG. 12 is a structural schematic diagram of a power generation device according to an embodiment 3 and an embodiment 4 of the present invention.

FIG. 13 is a left view of a power generation device according to an embodiment 3 and an embodiment 4 of the present invention.

FIG. 14 is a mounting schematic diagram of an electric generator according to an embodiment 3 and an embodiment 4 of the present invention.

In the drawings: 1. Upper plate; 2. Lower plate; 3. Wind deflector; 4. Electric generator; 5. First power impeller; 6. Second power impeller; 7. Center shaft; 8. Sleeve; 9. Blade; 10. Upper gear; 11. Upper partition plate; 12. Lower gear; 13. Lower partition plate; 14. Upper transition gear; 15. Lower transition gear; 16. Short shaft; 17. First power gear; 18. second power gear; 19. First bevel gear; 20. second bevel gear; 21. Empennage, 22. Pedestal; 23. Supporting shaft; 24. First supporting base; 25. Second supporting base; 26. Floating device; 27. fixing pile; 28. Rope; 29. Bearing; 30. Steering gear; 31. Steering shaft; 32. First steering bevel gear; 33. Second steering bevel gear; 34. Bevel gear box; 35. Transmission shaft; 36. Third steering bevel gear.

### DETAILED DESCRIPTION OF THE EMBODIMENTS

In the description of the present invention, it should be noted that orientations or position relationships indicated by terms “center”, “upper”, “lower”, “left”, “right”, “vertical”, “horizontal”, “inner”, “outer”, etc. are orientations or position relationships shown in the accompanying drawings, and these terms are only used to facilitate description of the present invention and simplify the description, but not to indicate or imply that the mentioned apparatus or components must have a specific orientation or must be established and operated in a specific orientation, and thus these terms cannot be understood as a limitation to the present invention. The terms “first”, “second” and “third” are used only for description and shall not be interpreted as an indication or implication of relative importance. In addition, unless otherwise specified and limited, the terms “mounting”, “connected” and “connection” should be understood in a broad sense, for example, they may be fixed connection, detachable connection or integrated connection; they may be mechanical connection or electrical connection; and they may be direct connection or indirect connection through an intermediate medium, or internal communication of two components. Those of ordinary skill in the art may understand specific meanings of the above-mentioned terms in the present invention based on the specific situation.

The present invention is further described below with reference to the embodiments.

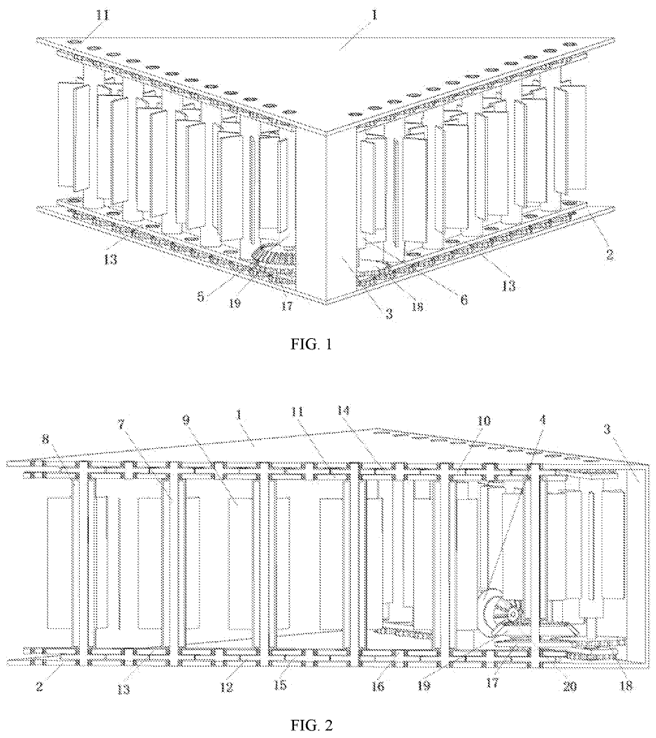

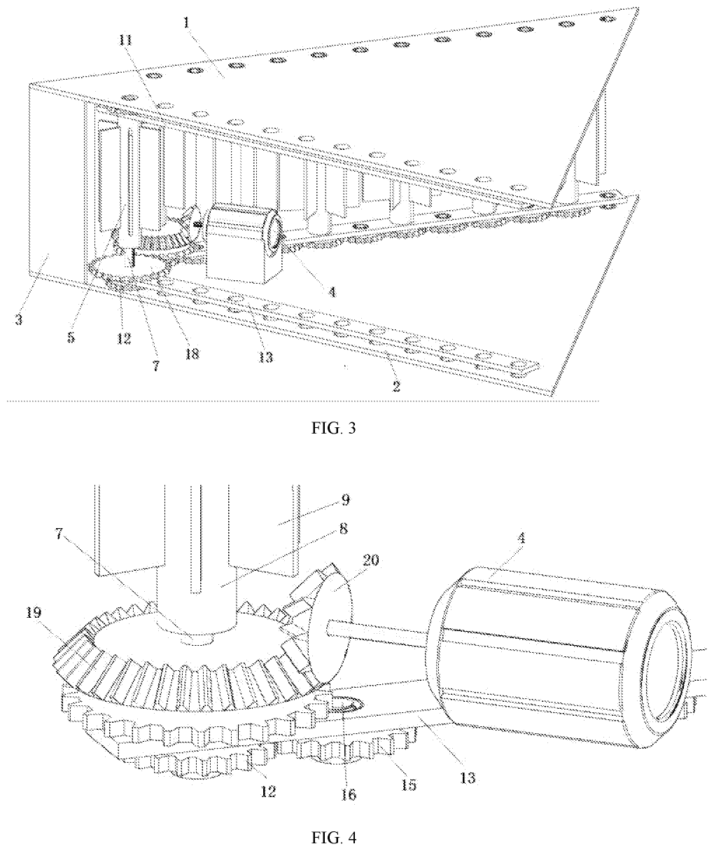

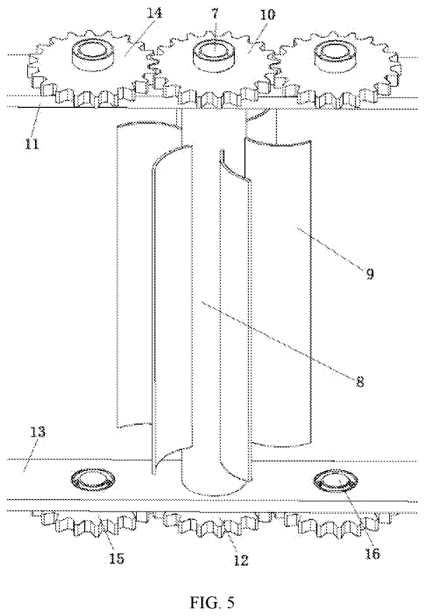

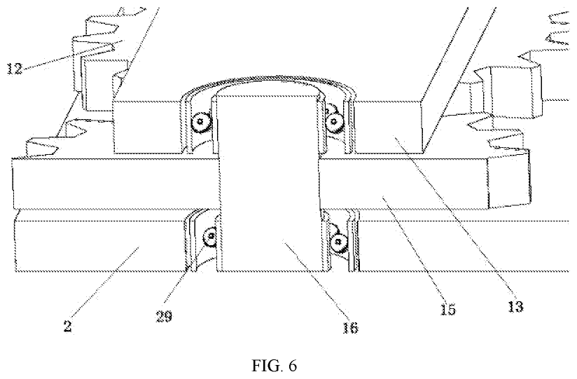

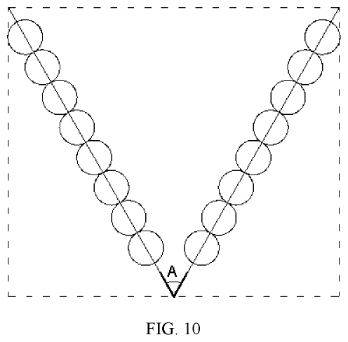

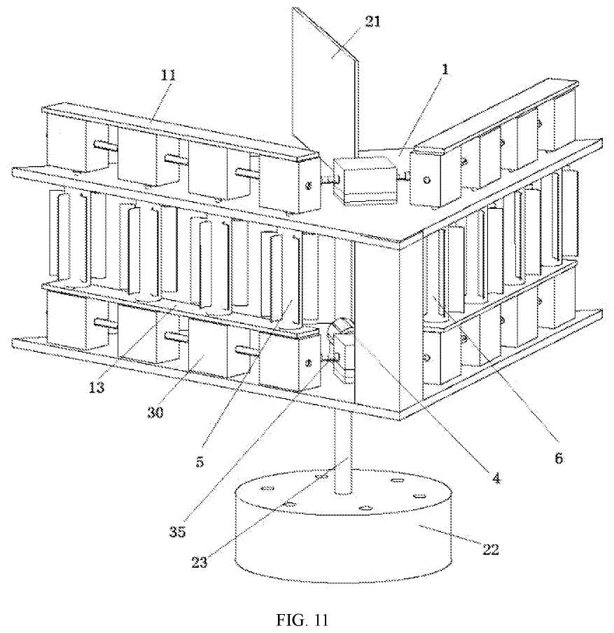

Embodiment 1: as shown in FIG. 1 to FIG. 6, a wind power generation device includes an upper plate 1, a lower plate 2, and impellers which are located between the upper plate 1 and the lower plate 2, wherein the upper plate 1 and the lower plate 2 are two triangular plates with the consistent size and direction and are arranged oppositely and parallelly with respect to each other, a plurality of impellers are arranged between the upper plate 1 and the lower plate 2, the impellers are arranged in two rows, the two rows of the impellers are distributed along two hypotenuses of the triangular plates, each row of the two rows of the impellers are connected through a transmission mechanism to realize synchronous rotation, and the wind deflector 3 is arranged at the included angle of the two rows of the impellers; as shown in FIG. 10, the included angle A of the two rows of the impellers is 55°, two sides are respectively parallel with the plane where the two rows of the impellers are located, the upper end and the lower end of the wind deflector 3 are fixed on the upper plate 1 and the lower plate 2 respectively; when wind blows from the tip side of the wind deflector 3, the wind deflector 3 may shield the wind, so that wind blows from both sides and blows along two sides of the wind deflector 3, and the impellers on the sides are driven to rotate;

the impeller includes a center shaft 7, a sleeve 8 and a plurality of blades 9; two ends of the center shaft 7 are connected to the upper plate 1 and the lower plate 2 respectively; the sleeve 8 is fixed outside the center shaft 7; the plurality of blades 9 are arranged outside the sleeve 8; the blades 9 may be straight plates, or may also be arc-shaped plates with radian; the blades 9 are fixedly connected to the sleeve 8 and the center shaft 7; and when the blades 9 rotate, the sleeve 8 and the center shaft 7 rotate together.

The transmission mechanism of each row of the two rows of the impellers is a plurality of gears which are engaged together and are divided into upper gears 10 and lower gears 12, each of the upper gears 10 is mounted outside the upper end of the center shaft 7, a first side of each of the upper gears 10 abuts against the upper plate, an upper partition plate 11 is arranged on a second side of each of the upper gears 10 opposite to the upper plate 1, and the upper gear 10 is located between the upper plate 1 and the upper partition plate 11; each of the lower gears is mounted outside a lower end of the center shaft 7, a first side of each of the lower gears 12 abuts against the lower plate 2, a lower partition plate 13 is arranged on a second side of each of the lower gears 12 opposite to the lower plate 2, and the lower gear 12 is located between the lower plate 2 and the lower partition plate 13; an upper transition gear 14 and a lower transition gear 15 are arranged between two adjacent center shafts 7, the upper transition gear 14 is located between two adjacent upper gears 10, and the upper transition gear 14 is fixed between the upper plate 1 and the upper partition plate 11 through a short shaft 16; the lower transition gear 15 is located between two adjacent lower gears 12, and the lower transition gear 15 is fixed between the lower plate 2 and the lower partition plate 13 through a short shaft 16; bearings 29 are arranged at the connections between the short shaft 16, and the upper plate 1, the lower plate 2, the upper partition plate 11 and the lower partition plate 13; when the wind blows, the blade 9 rotates to drive the sleeve 8 and the center shaft 7 to rotate synchronously; the bearings 29 are arranged at the connections between the center shaft 7, and the upper plate 1, the lower plate 2, the upper partition plate 11 and the lower partition plate 1, so rotation is not affected; the upper gear 10 and the lower gear 12 located on the center shaft 7 are fixedly connected to the center shaft 7, so synchronous rotation is realized; and due to the upper transition gear 14 and the lower transition gear 15, all the impellers may rotate together, an finally power can be transmitted to the gear closest to the wind deflector 3.

The two rows of the impellers include a first power impeller 5 and a second power impeller 6 which are closest to the wind deflector 3, a linkage structure is arranged between the first power impeller 5 and the second power impeller 6, the linkage structure between the first power impeller 5 and the second power impeller 6 is a first power gear 17 and a second power gear 18 which are engaged with each other, the first power gear 17 is arranged on the center shaft 7 of the first power impeller 5, the second power gear 18 is arranged on the center shaft 7 of the second power impeller 6, the first power gear 17 and the second power gear 18 are arranged close to the lower gears 12 and are located on one side of the lower partition plate 13 opposite to the lower gears 12, the first power gear 17 is in engaged connection with the second power gear 18, power of the two rows of the impellers may be concentrated on the first power gear 17 or the second power gear 18, the first power gear 17 or the second power gear 18 is connected to an electric generator 4, the power of the impeller may be converted into electric power, and the electric generator 4 is connected to the first power gear 17;

the first power impeller 5 transmits power to the electric generator 4 through the matched first bevel gear 19 and second bevel gear 20, the first bevel gear 19 is mounted on the center shaft 7 of the first power impeller 5, the first bevel gear 19 and the second bevel gear 20 are in engaged connection with each other, and the electric generator 4 is connected to the second bevel gear 20 through a transmission shaft; when wind blows, the impellers rotate, the first power gear 17 and the second power gear 18 gather the power of the two rows of the impellers on the first power gear 17; and when the first power gear 17 rotates, the first bevel gear 19 located on the center shaft 7 rotates synchronously, and the power of the impellers is transmitted to the electric generator 4 through the engaged second bevel gear 20.

When the wind power generation device is used, it is necessary to adjust the direction until the tip of the wind deflector 3 is positioned directly opposite to the wind direction, so that the wind energy can be utilized maximally.

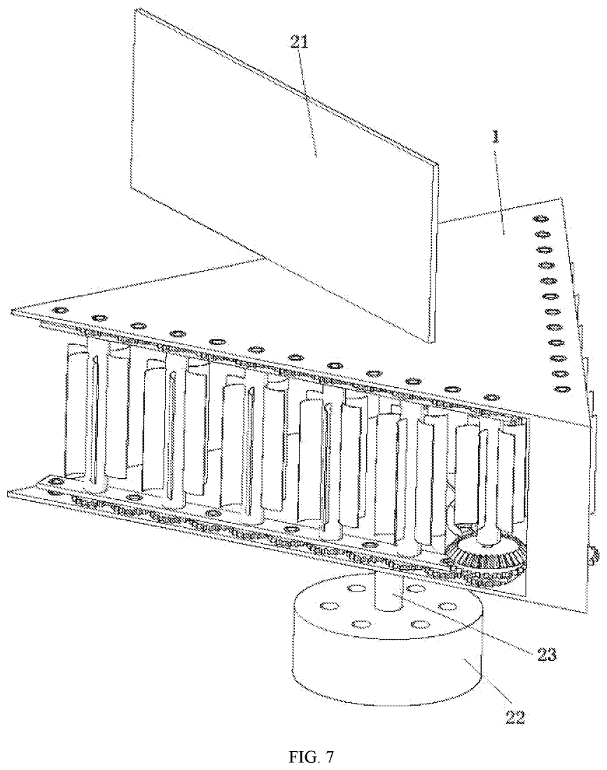

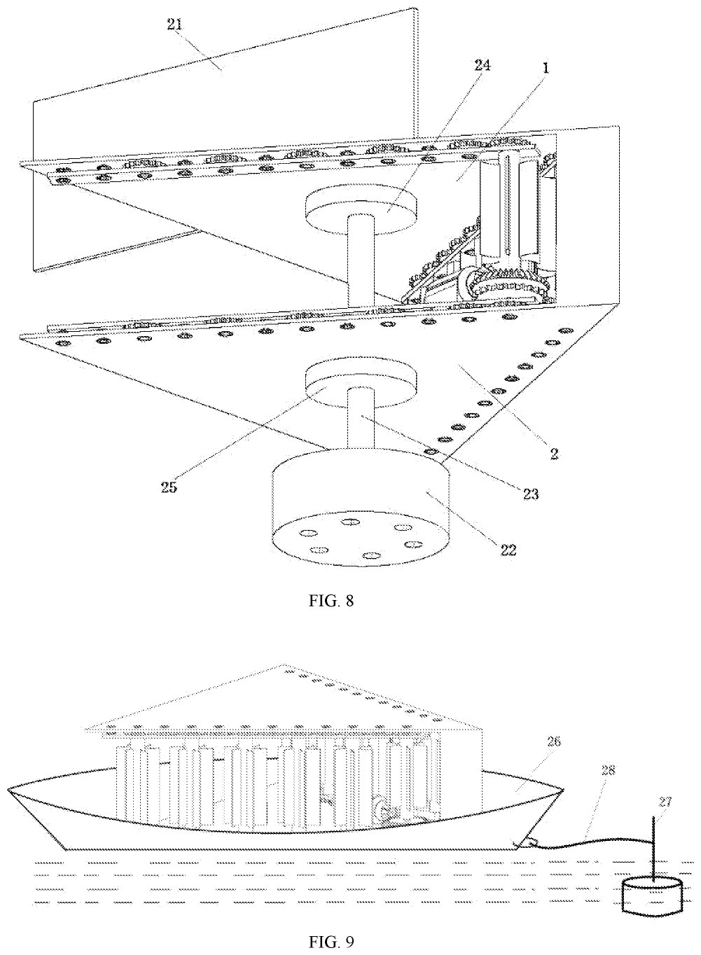

As shown in FIG. 7 to FIG. 8, when being applied to land, the wind power generation device needs to be fixed on the ground by a fixing device. The fixing device includes an empennage 21, a pedestal 22, a supporting shaft 23, a first supporting base 24 and a second supporting base 25, the first supporting base 24 is mounted on the lower surface of the upper plate 1, the second supporting base 25 is mounted on the lower surface of the lower plate 2, the positions of the first supporting base 24 and the second supporting base 25 correspond to each other up and down, the first supporting base 24 and the second supporting base 25 are connected through a supporting shaft 23 penetrating through the lower plate 2, the lower end of the supporting shaft 23 is fixed on the pedestal 22, and bearings 29 are arranged at the connections between the supporting shaft 23, and the first supporting base 24 and the second supporting base 25, so that the wind power generation device may rotate around the supporting shaft 23 and the pedestal 22, and the wind power generation device is consistent with the wind direction; the empennage 21 is mounted on the upper surface of the upper plate 1, arranged between the two rows of the impellers and distributed along the symmetry axis of the two rows of the impellers; the empennage 21 is provided to adjust the position of the wind power generation device timely; when there is an angle between the wind direction and the empennage 21, the wind power generation device rotates along the supporting shaft 23 under the action of wind power; meanwhile, the supporting shaft 23 is arranged on a connecting line of the gravity center of the wind power generation device and the end part of the wind deflector 3, that is, the gravity center of the wind power generation device is located on the rear side of the supporting shaft 23, so in the process that the wind power generation device rotates along the supporting shaft 23, the end part of the wind deflector 3 will face towards the blowing side, and the empennage is consistent with the wind direction.

During use, the pedestal 22 is fixed on a horizontal plane, and the wind power generation device is mounted on the pedestal 22. When wind blows, the empennage drives the wind power generation device to rotate, so that the end part of the wind deflector 3 faces the blowing position. At this time, the wind deflector 3 guides the wind to two sides, so that wind blows towards the impellers on two sides. The impellers transmit power through the gear in the rotation process. The first power gear 17 and the first bevel gear 19 are arranged on the center shaft 7 on which the lower gear 12 closest to the wind deflector is located, the first power gear 17 gathers the power of the impeller on the other side on the first power impeller 5, and the first bevel gear 19 transmits the finally gathered power to the electric generator 4 to realize power generation.

Embodiment 2: the structure of the wind power generation device is as same as that of the embodiment 1, but the application is different. In this embodiment, the wind power generation device is used on the sea surface for generating electricity.

As shown in FIG. 9, when the wind power generation device is used on the sea surface, the wind power generation device includes a floating device 26, a fixing pile 27 and a rope 28; the lower plate 2 of the wind power generation device is fixed on the floating device 26, the floating device 26 floats on the sea surface, one end of the floating device 26 is connected to the fixing pile 27 through the rope 28, the fixing pile 27 is fixed in the sea, and the connecting end of the rope 28 and the floating device 26 is positioned directly opposite to the tip of the wind deflector 3; when wind flows, the floating device 26 rotates along the fixing pile under the traction of the rope 28 until the floating device 26 keeps consistent with the rope 28 and the wind direction; the connecting end of the rope 28 and the floating device 26 is positioned directly opposite to the tip of the wind deflector 3, so at this time, the wind direction is positioned directly opposite to the tip of the wind deflector 3; the wind deflector 3 guides wind to two sides, so that the wind blows towards the impellers on two sides, and the impellers transmit power through the gears in the rotation process; the first power gear 17 and the first bevel gear 19 are arranged on the center shaft 7 on which the lower gear 12 closest to the wind deflector is located; and the first power gear 17 gathers the power of the impeller on the other side to the first power impeller 5, and the first bevel gear 19 transmits the finally gathered power to the electric generator 4 to generate electricity.

The floating device 26 mostly adopts a ship. During use, the wind deflector 3 of the wind power generation device is consistent with the direction of the prow, and the rope 28 is fixedly connected to the prow.

The above content of the present invention is further explained as follows:

according to the wind power generation device provided by the present invention, the impellers are used to convert wind power into kinetic energy; through the design of a plurality of gears, the kinetic energy is transmitted to the electric generator to realize wind power generation; and the wind power generation device has a simple structure, can change the size according to the requirement, may be applied to a sea surface or land and cooperates with different fixed structures to fulfill the aims of generating electricity under different environments.

In addition, the wind deflector is provided and may guide the wind, so that the wind moves in a V shape; then the impellers are set into two rows in a V shape to just correspond the wind passing through the wind deflector, and the wind drives the impellers to rotate to convert wind energy into kinetic energy; gears are arranged at the upper end and the lower end of each impeller, and the transition gear is arranged between the adjacent gears, so that all the impellers can rotate synchronously and power transmission between the impellers is realized; meanwhile, the two rows of the impellers are provided with two engaged power gears at the gathering end of the V-shaped end, the kinetic energy of the impellers on two sides may be gathered, and the kinetic energy of the impellers on two sides may be transmitted to the electric generator through one group of bevel gears, so that kinetic energy is converted into electric energy.

In addition, when the wind power generation device generates electricity on the land and is used in cooperation with the fixing device the direction can be changed at any time to be consistent with the wind direction from beginning to end, so that the power generation efficiency is improved; meanwhile, when the wind power generation device generates electricity on the sea surface and is used in cooperation with the floating device, the direction of the device may be changed with the wind direction so as to meet the use of the wind power generation device in different wind directions.

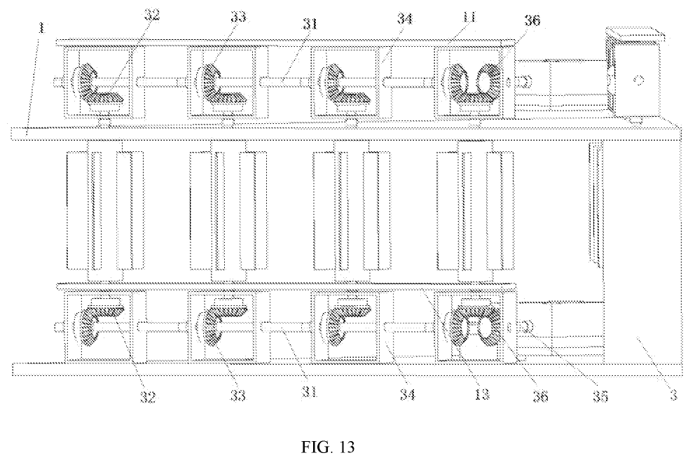

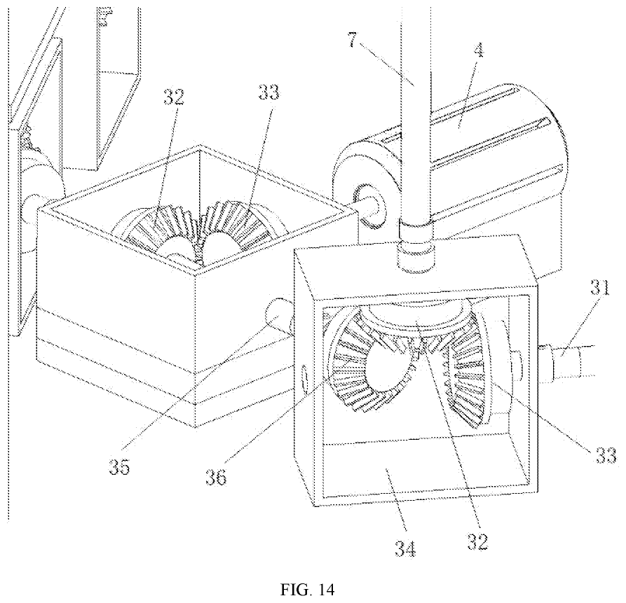

Embodiment 3: as shown in FIG. 10 to FIG. 14, a wind power generation device includes an upper plate 1, a lower plate 2, and impellers which are located between the upper plate 1 and the lower plate 2, wherein the upper plate 1 and the lower plate 2 are two triangular plates with the consistent size and direction and are arranged oppositely and parallelly with respect to each other, a plurality of impellers are arranged between the upper plate 1 and the lower plate 2, the impellers are arranged in two rows, the two rows of the impellers are distributed along two hypotenuses of the triangular plates, each row of the two rows of the impellers are connected through a transmission mechanism to realize synchronous rotation, and the wind deflector 3 is arranged at the included angle of the two rows of the impellers; as shown in FIG. 10, the included angle A of the two rows of the impellers is 50°, two sides are respectively parallel with the plane where the two rows of the impellers are located, the upper end and the lower end of the wind deflector 3 are fixed on the upper plate 1 and the lower plate 2 respectively; when wind blows from the tip side of the wind deflector 3, the wind deflector 3 may shield the wind, so that wind blows from both sides and blows along two sides of the wind deflector 3, and the impellers on the sides are driven to rotate;

the impeller includes a center shaft 7, a sleeve 8 and a plurality of blades 9; two ends of the center shaft 7 are connected to the upper plate 1 and the lower plate 2 respectively; the sleeve 8 is fixed outside the center shaft 7; the plurality of blades 9 are arranged outside the sleeve 8; the blades 9 may be straight plates, or may also be arc-shaped plates with radian; the blades 9 are fixedly connected to the sleeve 8 and the center shaft 7; and when the blades 9 rotate, the sleeve 8 and the center shaft 7 rotate together.

The transmission mechanism of each row of the two rows of the impellers includes a plurality of steering gears 30 which are connected together, the upper surfaces of the upper plate 1 and the lower plate 2 are respectively provided with two rows of the steering gears 30 along the distribution direction of the two rows of the impellers, the steering gears 30 on the upper and lower sides of each row of the two rows of the impellers are connected together through one steering shaft 31, the steering gear 30 includes a gear box 34, and a first steering bevel gear 32 and a second steering bevel gear 33 which are located in the gear box 34, and the first steering bevel gear 32 and the second steering bevel gear 33 are in engaged with each other; the first bearing bevel gear 32 in each steering gear 30 is fixedly connected to the end part of the center shaft 7 of the corresponding impeller; when the center shaft 7 rotates, the first steering bevel gears 32 at two ends rotate synchronously, the engaged second steering bevel gear 33 rotates together, and the second steering bevel gear 33 is connected to the steering shaft 31; when the second steering bevel gear 33 rotates, the steering shaft 31 rotates together, and a bearing is arranged at the connection position of the steering shaft 31 and the gear box 34;

the upper surfaces of the upper plate 1 and the lower plate 2 are fixedly connected to an upper partition plate 11 and a lower partition plate 13 respectively; the upper partition plate 11 and the lower partition plate 13 are mounted on the upper plate 1 and the lower plate 2 through a bracket or other fixing structures; spaces capable of accommodating the steering gears 30 are formed between the upper partition plate 11 and the upper plate 1, and between the lower partition plate 13 and the lower plate 2; the steering gear 30 mounted on the upper surface of the upper plate 1 and the steering shaft 31 are located between the upper plate 1 and the upper partition plate 11; the steering gear 30 mounted on the upper surface of the lower plate 2 and the steering shaft 31 are located between the lower plate 2 and the lower partition plate 13; the upper end and the lower end of the center shaft 7 are connected to the upper partition plate 11 and the lower partition plate 13 through the bearing; and the upper partition plate 11 and the lower partition plate 13 are provided to reduce the pressure applied by the center shaft 7 to the steering gear 30.

The linkage structure between the first power impeller 5 and the second power impeller 6 includes a transmission shaft 35 and a third steering bevel gear 36; when the impeller rotates, the first steering bevel gears 32 at the two ends of the impeller rotate synchronously, and the steering shaft 31 rotates through the transmission of the second steering bevel gear 33, so when wind blows, no matter which impeller rotates, the first power impeller 5 and the second power impeller 6 will be finally driven to rotate; one third steering bevel gear 36 is arranged in each of the steering gears 30 connected below the first power impeller 5 and the second power impeller 6, and the two third steering bevel gears 36 are engaged with the first steering bevel gears 32 in the two steering gears 30 respectively; when the first power impeller 5 and the second power impeller 6 rotate, the first steering bevel gear 32 will drive the third steering bevel gear 36 to rotate; one transmission shaft 35 is arranged between the two third steering bevel gears 36; when the third steering bevel gear 36 rotates, the transmission shaft 35 rotate synchronously; one steering gear 30 is arranged in the middle of the transmission shaft 35, and the electric generator 4 is connected to the steering gear 30; the first steering bevel gear 32 of the steering gear 30 is mounted on the transmission shaft 35, and the second steering bevel gear 33 is connected to the electric generator 4; when the transmission shaft 35 rotates, the first steering bevel gear 32 located on the transmission shaft 35 rotates synchronously, the second steering bevel gear 33 is driven to rotate, and the generated kinetic energy will be transmitted to the electric generator 4.

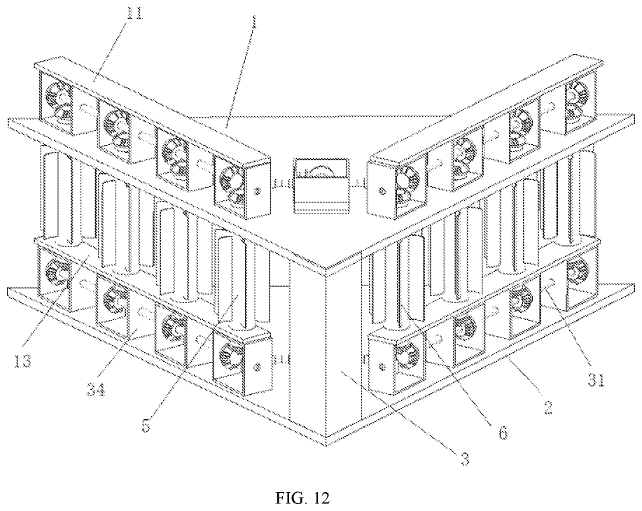

As shown in FIG. 11, when being applied to land, the wind power generation device needs to be fixed on the ground by a fixing device. The fixing device includes an empennage 21, a pedestal 22, a supporting shaft 23, a first supporting base 24 and a second supporting base 25, the first supporting base 24 is mounted on the lower surface of the upper plate 1, the second supporting base 25 is mounted on the lower surface of the lower plate 2, the positions of the first supporting base 24 and the second supporting base 25 correspond to each other up and down, the first supporting base 24 and the second supporting base 25 are connected through a supporting shaft 23 penetrating through the lower plate 2, the lower end of the supporting shaft 23 is fixed on the pedestal 22, and bearings 29 are arranged at the connections between the supporting shaft 23, and the first supporting base 24 and the second supporting base 25, so that the wind power generation device may rotate around the supporting shaft 23 and the pedestal 22, and the wind power generation device is consistent with the wind direction; the empennage 21 is mounted on the upper surface of the upper plate 1, arranged between the two rows of the impellers and distributed along the symmetry axis of the two rows of the impellers; the empennage 21 is provided to adjust the position of the wind power generation device timely; when there is an angle between the wind direction and the empennage 21, the wind power generation device rotates along the supporting shaft 23 under the action of wind power; meanwhile, the supporting shaft 23 is arranged on a connecting line of the gravity center of the wind power generation device and the end part of the wind deflector 3, that is, the gravity center of the wind power generation device is located on the rear side of the supporting shaft 23, so in the process that the wind power generation device rotates along the supporting shaft 23, the end part of the wind deflector 3 will face towards the blowing side, and the empennage is consistent with the wind direction.

During use, the pedestal 22 is fixed on a horizontal plane, and the wind power generation device is mounted on the pedestal 22. When wind blows, the empennage drives the wind power generation device to rotate, so that the end part of the wind deflector 3 faces the blowing position. At this time, the wind deflector 3 guides the wind to two sides, so that wind blows towards the impellers on two sides. The impellers transmit power through the steering gear in the rotation process. One third steering bevel gear 36 is arranged on each of two steering gears 30 closest to the wind deflector; and through rotation of the impellers, the force is finally transmitted to the third steering bevel gear 36, the third steering bevel gear 36 drives the transmission shaft 35 and the steering gear 30 on the transmission shaft 35, and the force is transmitted to the electric generator 4 to generate electricity.

Embodiment 4: the structure of the wind power generation device is as same as that of the embodiment 3, but the application is different. In this embodiment, the wind power generation device is used on the sea surface for generating electricity.

As shown in FIG. 9, when the wind power generation device is used on the sea surface, the wind power generation device includes a floating device 26, a fixing pile 27 and a rope 28; the lower plate 2 of the wind power generation device is fixed on the floating device 26, the floating device 26 floats on the sea surface, one end of the floating device 26 is connected to the fixing pile 27 through the rope 28, the fixing pile 27 is fixed in the sea, and the connecting end of the rope 28 and the floating device 26 is positioned directly opposite to the tip of the wind deflector 3; when wind flows, the floating device 26 rotates along the fixing pile under the traction of the rope 28 until the floating device 26 keeps consistent with the rope 28 and the wind direction; the connecting end of the rope 28 and the floating device 26 is positioned directly opposite to the tip of the wind deflector 3, so at this time, the wind direction is positioned directly opposite to the tip of the wind deflector 3; the wind deflector 3 guides wind to two sides, so that the wind blows towards the impellers on two sides, and the impellers transmit power through the gears in the rotation process; one third steering bevel gear 36 is arranged in each of the two steering gears 30 closest to the wind deflector; and through the rotation of the impellers, and the force is finally transmitted to the third steering bevel gear 36; and the third steering bevel gear 36 drives the transmission shaft 35 and the steering gear 30 on the transmission shaft 35, and the force is transmitted to the electric generator 4 to generate electricity.

The floating device 26 mostly adopts a ship. During use, the wind deflector 3 of the wind power generation device is consistent with the direction of the prow, and the rope 28 is fixedly connected to the prow.

The above content of the present invention is further explained as follows:

according to the wind power generation device provided by the present invention, the impellers are used to convert wind power into kinetic energy; through the design of a plurality of steering gears, the kinetic energy is transmitted to the electric generator to realize wind power generation, and the steering gear can reduce the mass of the whole device; and the wind power generation device has a simple structure, can change the size according to the requirement, may be applied to a sea surface or land and cooperates with different fixed structures to fulfill the aims of generating electricity under different environments.

In addition, the wind deflector is provided and may guide the wind, so that the wind moves in a V shape; then the impellers are set into two rows in a V shape to just correspond the wind passing through the wind deflector, and the wind drives the impellers to rotate to convert wind energy into kinetic energy; steering gears are arranged at the upper end and the lower end of each impeller, and a steering shaft is arranged on the steering gear, so that all the impellers can rotate synchronously and power transmission between the impellers is realized; meanwhile, the two rows of the impellers are provided with the third steering bevel gear and the rotating shaft at the gathering end of the V-shaped end, the kinetic energy of the impellers on two sides may be gathered, the kinetic energy of the impellers on two sides may be gathered, and finally the kinetic energy is transmitted to the electric generator through one group of steering gear, so that kinetic energy is converted into electric energy.

In addition, when the wind power generation device generates electricity on the land and is used in cooperation with the fixing device the direction can be changed at any time to be consistent with the wind direction from beginning to end, so that the power generation efficiency is improved; meanwhile, when the wind power generation device generates electricity on the sea surface and is used in cooperation with the floating device, the direction of the device may be changed with the wind direction so as to meet the use of the wind power generation device in different wind directions.

The present invention only writes the power generation device with the single-layer structure in detail. The device may be stacked with a plurality of layers in the actual use process, and the lower plate and the upper plate of the adjacent two layers of power generation device are fixed, so that the obtained total power generation device has a plurality of electric generators, more wind energy can be collected and the power generation efficiency can be improved.

The above embodiments are only for describing the technical concept and the characteristics of the present invention, are intended to make people familiar with the technology understand the content of the present invention for implementation, but cannot limit the protection scope of the present invention. Equivalent changes or modifications made according to the spirit of the present invention should be covered within the protection scope of the present invention.

What is claimed is:

1. A wind power generation device, comprising an upper plate, a lower plate, and impellers located between the upper plate and the lower plate, wherein the upper plate and the lower plate are arranged oppositely and parallelly with respect to each other; the impellers are arranged between the upper plate and the lower plate; the impellers are arranged in two rows; each row of the two rows of the impellers are connected through a transmission mechanism to realize synchronous rotation; two planes where the two rows of the impellers are located form an included angle; a wind deflector is arranged at the included angle; the two rows of the impellers comprise a first power impeller and a second power impeller, wherein the first power impeller and the second power impeller are closest to the wind deflector; a linkage structure is arranged between the first power impeller and the second power impeller; and the linkage structure is connected to an electric generator.

2. The wind power generation device according to claim 1, wherein each of the impellers comprises a center shaft, a sleeve, and a plurality of blades; two ends of the center shaft are connected to the upper plate and the lower plate respectively; the sleeve is fixed outside the center shaft; and the plurality of blades are arranged outside the sleeve.

3. The wind power generation device according to claim 2, wherein the transmission mechanism of each row of the two rows of the impellers is a plurality of gears, the plurality of gears are engaged together and divided into upper gears and lower gears, each of the upper gears is mounted outside an upper end of the center shaft, a first side of each of the upper gears abuts against the upper plate, an upper partition plate is arranged on a second side of each of the upper gears opposite to the upper plate, and the upper gears are located between the upper plate and the upper partition plate; each of the lower gears is mounted outside a lower end of the center shaft, a first side of each of the lower gears abuts against the lower plate, a lower partition plate is arranged on a second side of each of the lower gears opposite to the lower plate, and the lower gears are located between the lower plate and the lower partition plate;
an upper transition gear and a lower transition gear are arranged between two adjacent center shafts, the upper transition gear is located between two adjacent upper gears, and the upper transition gear is fixed between the upper plate and the upper partition plate through a short shaft; and the lower transition gear is located between two adjacent lower gears, and the lower transition gear is fixed between the lower plate and the lower partition plate through the short shaft.

4. The wind power generation device according to claim 3, wherein the linkage structure between the first power impeller and the second power impeller is a first power gear and a second power gear, the first power gear and the second power gear are engaged with each other, the first power gear is arranged on the center shaft of the first power impeller, the second power gear is arranged on the center shaft of the second power impeller, and the first power gear and the second power gear are arranged close to the lower gears and are located on one side of the lower partition plate opposite to the lower gears; and
the first power impeller transmits power to the electric generator through a first bevel gear and a second bevel gear, the first bevel gear and the second bevel gear are matched with each other, the first bevel gear is mounted on the center shaft of the first power impeller, the first bevel gear is in an engaged connection with the second bevel gear, and the electric generator is connected to the second bevel gear through a transmission shaft.

5. The wind power generation device according to claim 2, wherein the transmission mechanism of each row of the two rows of the impellers comprises steering gears, each of the steering gears comprises a gear box, and a first steering bevel gear and a second steering bevel gear, the first steering bevel gear and the second steering bevel gear are located in the gear box, and the first steering bevel gear and the second steering bevel gear are in an engaged connection with each other; an upper surface of the upper plate and an upper surface of the lower plate are respectively provided with two rows of the steering gears arranged in a distribution direction of the two rows of the plurality of impellers, each row of the two rows of the steering gears are connected together through a steering shaft, the first steering bevel gear in each of the plurality of steering gears is fixedly connected to an end part of the center shaft of a corresponding impeller, the second steering bevel gear is connected to the steering shaft, and when the corresponding impeller rotates, the center shaft and the first steering bevel gear rotate synchronously and simultaneously drive the second steering bevel gear to rotate; and
the upper surface of the upper plate and the upper surface of the lower plate are fixedly connected to an upper partition plate and a lower partition plate respectively, a first steering gear mounted on the upper surface of the upper plate and the steering shaft are located between the upper plate and the upper partition plate, and a second steering gear mounted on the upper surface of the lower plate and the steering shaft are located between the lower plate and the lower partition plate.

6. The wind power generation device according to claim 5, wherein the linkage structure between the first power impeller and the second power impeller comprises a transmission shaft and two third steering bevel gears, each of the two third steering bevel gears is arranged in each of two steering gears connected below the first power impeller and the second power impeller, the two third steering bevel gears are respectively engaged with first steering bevel gears in the two steering gears, the transmission shaft is arranged between the two third steering bevel gears, and when the third steering bevel gear rotates, the transmission shaft rotates synchronously, one steering gear is arranged in a middle of the transmission shaft, and the electric generator is connected to one steering gear; and the first steering bevel gears in the two steering gears are mounted on the transmission shaft, and the second steering bevel gear is connected to the electric generator.

7. The wind power generation device according to claim 4, wherein bearings are arranged at connections between the center shaft and the upper plate, between the center shaft and the lower plate, between the center shaft and the upper partition plate and between the center shaft and the lower partition plate.

8. The wind power generation device according to claim 1, wherein the upper plate and the lower plate are two triangular plates with a consistent direction, the two rows of the impellers are distributed along two hypotenuses of the triangular plates, the wind deflector is arranged at the included angle of the two rows of the impellers, the included angle of the two rows of the impellers is 50°-60°, two sides of the wind deflector are respectively parallel with the two planes where the two rows of the impellers are located, and an upper end and lower end of the wind deflector are fixed on the upper plate and the lower plate respectively.

9. The wind power generation device according to claim 1, wherein when being used on the land, the wind power generation device further comprises a fixing device, the fixing device comprises an empennage, a pedestal, a supporting shaft, a first supporting base, and a second supporting base, wherein the first supporting base is mounted on a lower surface of the upper plate, the second supporting base is mounted on a lower surface of the lower plate, positions of the first supporting base and the second supporting base correspond to each other up and down, the first supporting base and the second supporting base are connected through the supporting shaft penetrating through the lower plate, a lower end of the supporting shaft is fixed on the pedestal, and bearings are arranged at connections between the supporting shaft and the first supporting base, and between the supporting shaft and the second supporting base; and the empennage is mounted on an upper surface of the upper plate, arranged between the two rows of the impellers and distributed along a symmetry axis of the two rows of the impellers, and a tail end of the empennage extends outside the upper plate.

10. The wind power generation device according to claim 1, wherein when being used at the sea surface, the wind power generation device further comprises a floating device, a fixing pile, and a rope; the lower plate is fixed on the floating device; the floating device floats on the water surface, one end of the floating device is connected to the fixing pile through the rope, the fixing pile is fixed under water, and connecting ends of the rope and the floating device are positioned directly opposite to a tip of the wind deflector.

11. The wind power generation device according to claim 6, wherein bearings are arranged at connections between the center shaft and the upper plate, between the center shaft and the lower plate, between the center shaft and the upper partition plate and between the center shaft and the lower partition plate.
